(19) United States
(12) Patent Application Publication
(10) Pub. No.: US 2009/0296956 A1
(43) Pub. Date: Dec. 3, 2009

(54) Motorcycle speaker assembly

(75) Inventor: Marvin Alan Gregory, Willis, TX (US)

Correspondence Address: R. PERRY MCCONNELL, P.C., 9001 FOREST CROSSING, SUITE F, THE WOODLANDS, TX, 77381, US

(73) Assignee: Street Star Designs, LLC

(21) Appl. No.: 12/154,807

(22) Filed: May 27, 2008

(51) Int. Cl. H04B 1/00

(52) U.S. Cl. 381/86

(57) ABSTRACT

A speaker assembly for a motorcycle which comprises a mounting portion adaptable to a motorcycle saddlebag and a mounting portion positioning a speaker to direct the speaker output towards the rider of the motorcycle.

### FIELD OF THE INVENTION

The invention concerns speaker mounts for motorcycles, specifically mount assemblies that direct the speaker output to the rider of the motorcycle and which are adapted to be exchangeable with existing equipment, such as saddlebag covers.

### BACKGROUND OF THE INVENTION

Sound systems are often used on motorcycles, as with automobiles, to provide the rider with access to radio programming or to play music or other recordings. Automobiles provide a large degree of flexibility in mounting such systems, with a variety of options for positioning speakers. Additionally, an automobile generally provides some insulation from wind and road noise.

Unlike automobiles, a motorcycle rider's ability to listen to such systems may be hampered by wind, road, and engine noise. Further, possible speaker mounting locations are limited, and the relatively narrow width of motorcycles hinders the adequate separation of stereo speakers. Speakers can be attached to handlebar mounts, but the relatively large size of modern sound system speakers can make such mounting both difficult and unattractive, and small speakers can fail to provide acceptable sound quality. Additionally, vibration transmitted though such mountings can be deleterious to the speakers, themselves.

Other alternatives for speaker mounting exist. For example, a rider may have headset speakers mounted inside a helmet. However, such approaches may be undesirable as they require the rider to always wear the helmet, and force the rider to effectively plug himself in when mounting the motorcycle, and to unplug himself when dismounting. Additionally, having sound system speakers in close proximity to the ears may hamper a rider's ability to hear other sounds, such as those of approaching cars.

Some riders have attempted to mount speakers rearward of the rider, such as by cutting mounting holes in the sides or tops of hard saddlebags. Such configurations succeed in mounting the speaker, but leave the sound directed either straight up or forward rather than toward the rider.

Accordingly, it is desirable to provide a mounting system for speakers for a motorcycle that directs the speaker output toward the motorcycle rider and additionally allows the speakers to be mounted so that they are as protected as possible from environmental conditions such as vibration.

### SUMMARY OF THE INVENTION

The invention comprises a speaker mounting assembly for a motorcycle sound system, and in a preferred embodiment is adaptable to replace the lids of “hard” saddlebags. Such saddlebags are generally made of a durable plastic or materials such as fiberglass, and are mounted on either side of a motorcycle's rear wheel. The lids of such saddlebags are configured to provide a secure, close-fitting cover for the saddlebag and thus to keep dirt and moisture from the interior, protecting any property inside.

In a preferred embodiment, the speaker mount of the present invention comprises a replacement saddlebag lid with an integral speaker mount. In this preferred embodiment, the replacement lid is shaped so that, when a speaker is mounted in the lid and the lid is placed on the saddlebag in the closed position, the speaker will be directed upward and inward so that its output is directed toward the head of the rider. Those of skill in the art will recognize that a set of two of such mounts will comprise a left-hand and a right-hand version so that speakers may be mounted on the saddlebags on either side of the rear tire.

In a preferred embodiment of the invention, the speaker mount will be near the forward part of the replacement saddlebag lid, so that the positioning of the speaker will provide optimal sound performance and minimal interference with a second rider, if one is on the motorcycle. However, without departing from the spirit of the invention, it is possible to place speakers near the center or to the rear of the replacement saddlebag lid, to mount multiple speakers therein, or to provide a replacement lid comprising multiple, interchangeable sections.

Also in a preferred embodiment of the present invention, the speaker's outer surface will be substantially flush with the outer surface of the replacement lid in an essentially sealed configuration. Electrical connections to the speaker will be internal to the saddlebag, and thus protected from the environment. Speaker connecting wires may be run through the sides or bottom of the saddlebag, or through the replacement lid, in an inconspicuous fashion. Such connections may be made with releasable bulkhead connectors if desired, so that the saddlebag may be “unplugged,” or disconnected from the sound system if it is desirable to dis-mount the saddlebag. Similarly, releasable connectors to the speakers may be used in the event that it is desirable to remove the replacement lid and utilize the original lid for a period of time.

### BRIEF DESCRIPTION OF THE DRAWINGS

FIG. 1 is an oblique perspective view of one embodiment of the present invention.

### DETAILED DESCRIPTION

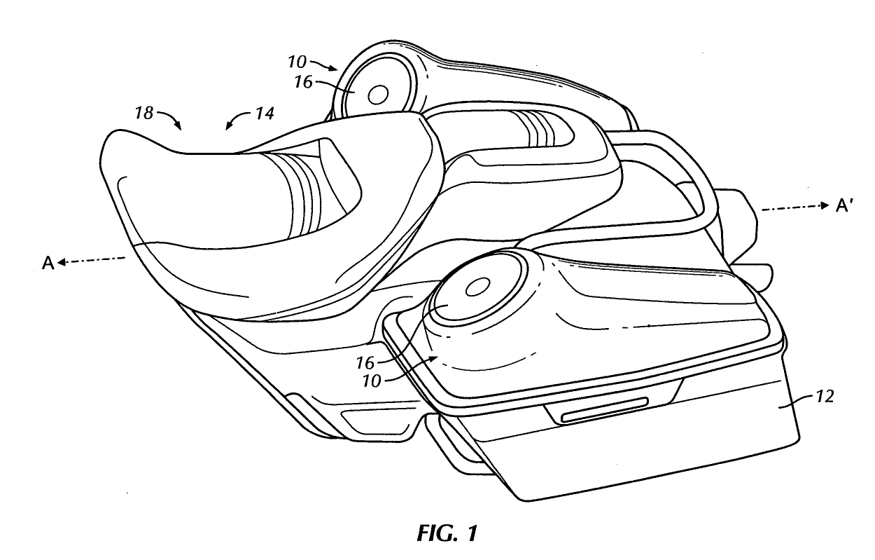

Referring to FIG. 1, an embodiment of the present invention is shown. Saddlebag lids 10 are mounted on hard saddlebags 12, which in turn are attached to the rear portion of a motorcycle 14. In a preferred embodiment, saddlebag lids 10 are designed to be interchangeable with, and direct replacements for, the original lids (not shown) for the hard saddlebags 12. Speakers 16 are mounted in the saddlebag lids 10, and are oriented so that they are directed upward and inward to the centerline A-A′ of the motorcycle. Thus, sound output from the speakers 16 is directed upward and inward to a rider (not shown), who will be positioned on seat 18.

In a preferred embodiment of the invention, saddlebag lids 10 are formed of a plastic material, preferably a polycarbonate/ABS alloy (a blend of polycarbonate and acrylonitrile butadiene styrene polymer). However, other materials, such as fiberglass or wood, may also be used for reasons of esthetics or cost. Speakers 16 are preferably mounted so that they form an essentially sealing join with saddlebag lids 10 to prevent dirt and moisture from reaching the interior of the saddlebags 12.

The above examples are included for demonstration purposes only and not as limitations on the scope of the invention. Other variations in the construction of the invention may be made without departing from the spirit of the invention, and those of skill in the art will recognize that these descriptions are provide by way of example only.

I claim:

1. A speaker assembly adapted to a saddlebag for a motorcycle, wherein said speaker assembly comprises a lid for said saddlebag, wherein said lid comprises a speaker, and wherein said speaker is directed upwards and toward the centerline of said motorcycle.

2. The speaker assembly of claim 1, wherein said speaker is releasably attached to said lid.

3. The speaker assembly of claim 1, wherein said lid is constructed of a plastic material.

4. The speaker assembly of claim 3, wherein said plastic material is a polycarbonate/ABS alloy.

5. The speaker assembly of claim 1, wherein said lid is constructed of wood.

6. The speaker assembly of claim 1, wherein said lid is constructed of fiberglass.

7. The speaker assembly of claim 1, wherein said speaker comprises a selectively releasable electrical connection.
